(19) United States
(12) Patent Application Publication
(10) Pub. No.: US 2008/0318557 A1
(43) Pub. Date: Dec. 25, 2008

(54) Broadcast of time signal over general purpose wireless network

(76) Inventors: Joshua R. Poulson, Ridgefield, WA (US); Alexander C. Johnson, Portland, OR (US); Scott W. Nelson, Beaverton, OR (US); Hal A. Porter, Portland, OR (US)

Correspondence Address: LAW OFFICES OF MICHAEL DRYJA, 1474 N COOPER RD #105-248, GILBERT, AZ, 85233, US

(21) Appl. No.: 11/767,748

(22) Filed: Jun. 25, 2007

(51) Int. Cl. H04M 3/42; H04H 1/00; H04Q 7/20

(52) U.S. Cl. 455/414.1; 455/3.01; 455/466

(57) ABSTRACT

A transmitting device wirelessly broadcasts a time signal over a general purpose wireless network. A receiving device wirelessly receives the time signal without having established a connection with the transmitting device. The receiving device sets a lock thereof based on the time signal. The general purpose wireless network can be an 802.11a, an 802.11b, an 802.11g, an 802.11n, and/or a Bluetooth wireless network over which the transmitting device communicates with devices, other than the receiving device that are connected to the transmitting device. The general purpose wireless network can further be a mobile phone network over which the transmitting device communicates with devices, other than the receiving device, that are connected to the transmitting device.

### FIELD OF THE INVENTION

The present invention relates generally to the broadcasting of time signals, and more particularly to the broadcasting of time signals over a general purpose wireless network, such that receiving devices can receive the time signal without having to establish connections with the transmitting device that broadcast the time signal.

### BACKGROUND OF THE INVENTION

Modern home and office environments are littered with electronic devices that have digital clocks. Examples of such electronic devices include cooking appliances like microwave ovens and ranges or stoves, alarm clocks, and audio/video components like video cassette recorders (VCR's), DVD players, and digital video recorders (DVR's), among other types of electronic devices. Typically, users have to manually set the clock for each device, the process for which can be sufficiently complicated that many users do not do so.

Even when the users manually set the clock for each electronic device, the electronic devices may nevertheless not be synchronized with one another. The user may have set the clocks for the electronic devices at different times, with times that are not synchronized with one another. Furthermore, many digital clocks exhibit time drift, which means that over time, the digital clocks become inaccurate by seconds or minutes. Because different devices may have different rates of time draft, their digital clocks can display different times even if they were synchronized at some point.

One limited solution to this problem is to include in such electronic devices receiving components that are capable of tuning to the time signal broadcast by the US government from Boulder, Colo. So-called “atomic” clocks receive this time signal, and in response set themselves. However, the user still has to specify the local time zone, as the Boulder-based time signal is correct just as to a particular time zone that may be different than that in which the electronic device is located. Furthermore, the atomic time signal broadcast is relatively faint, and frequently cannot be received indoors, rendering the atomic clocks substantially useless.

Another limited solution is for network-connected devices to receive the correct time from another device on the network. For example, computing devices like desktop and laptop computers are able to connect to a server or other device over a network in a wired or wireless manner. Besides receiving and sending information over the network, such a computing device may receive data representing the local time while it is connected to the server or other device, and in response set its internal clock. However, this solution cannot be used for electronic devices like alarm clocks and cooking devices that do not have network connection functionality, and including such networking functionality into these electronic devices can be cost prohibitive. Furthermore, many users have difficulty setting up electronic devices for network connectivity, and may choose to set their clocks manually even if the devices have such network connection capability.

As another example, mobile phone devices are able to connect to a mobile phone tower device over a mobile phone network. Besides making and receiving phone calls over the network, or send and receive other information over the network, a mobile phone device may receive data representing the local time while it is connected to the mobile phone tower device, and in response set its internal clock. This solution also cannot be used for electronic devices like alarm clocks and cooking devices that do not have mobile phone communication capability, and including such functionality into these electronic devices can be cost prohibitive, too. For these and other reasons, therefore, there is a need for the present invention.

### SUMMARY OF THE INVENTION

The present invention relates to the broadcast of a time signal over a general purpose wireless network. In one embodiment of the invention, a transmitting device wirelessly broadcasts a time signal over a general purpose wireless network. A receiving device wirelessly receives the time signal, without having established a connection with the transmitting device. The receiving device then sets a clock thereof, based on the time signal wirelessly received.

Embodiments of the invention provide for advantages over the prior art. The general purpose wireless network can be an 802.11a, 802.11b, 802.11g, 802.11n, and/or a Bluetooth wireless network, such as those commonly found in homes and offices. The general purpose wireless network may alternatively be a mobile phone network of the type that blankets most of the United States. Thus, the receiving device is likely to be located in an area in which it can receive the wirelessly broadcast time signal, without the difficulty associated with the Boulder, Colo.-based atomic clock transmitter.

The receiving device, however, does not have to establish a connection with the transmitting device over the general purpose wireless network. As such, the user does not have to perform any special type of configuration of the receiving device in order for the device to properly receive the time signal. Furthermore, the wireless receiving component of the receiving device that actually receives the time signal can be a low-cost integrated circuit (IC), insofar as it may be unable to transmit signals over the general purpose wireless network. Such a component is in contradistinction to a component of a computing device or a mobile phone device that is more sophisticated since it has to both send and receive information over the network, and thus is more costly.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method, according to an embodiment of the invention.

FIG. 2 is a diagram of a system, according to an embodiment of the invention.

FIG. 3 is a diagram of a wireless receiving component for a receiving device, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Method

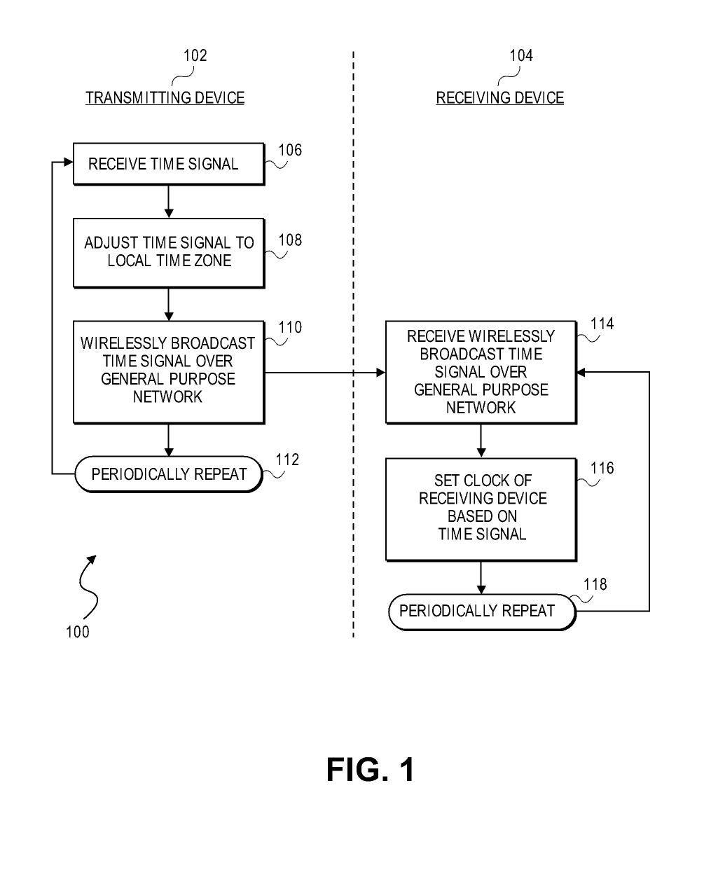

FIG. 1 shows a method 100, according to an embodiment of the invention. Parts of the method 100 in the left-most column are performed by a transmitting device 102, whereas parts of the method 100 in the right-most column are performed by a receiving device 104. The transmitting device 102 is able to communicate over a general-purpose network. A general-purpose wireless network is non-restrictively and generally defined herein as a wireless network over which data is normally sent and received among devices connected to the network.

For example, the general-purpose wireless network may be a wireless Ethernet network of the type commonly found in home and office environments, such as one or more of the 802.11a, 802.11b, 802.11g, and 802.11n wireless networks, and/or a Bluetooth network. In such instance, the transmitting device 102 may be a router or an access point that enables other devices, such as client devices like laptop computers, to communicate with one another and with the transmitting device 102. The transmitting device 102 may further enable these devices to connect to the Internet, an intranet, an extranet, or another type of network.

These devices thus establish connections with the transmitting device 102, so that they may send data to and receive data from or via the transmitting device 102. For instance, such a client device may when turned on send a beacon signal looking for a transmitting device 102. In response, the transmitting device 102 may provide the client device with a network address, such that the client device is now connected to the wireless network and to the transmitting device 102. Once the client device is so connected, it is able to wirelessly transmit data to and wirelessly receive data from the transmitting device 102, and other devices on the wireless network.

By comparison, the receiving device 104 is not a client device that actually connects to the transmitting device 102 or the general-purpose wireless network in question. The receiving device 104, for instance, may have no wireless transmission capability, and thus may only be able to receive wireless signals sent over the wireless network. As such, the receiving device 104 is not actually connected to the general-purpose wireless network, nor to the transmitting device 102. When the transmitting device 102 broadcasts a time signal, for instance, as will be described, it does not know that the receiving device 104 has received the time signal, and in fact has no knowledge of the receiving device 104. By comparison, the transmitting device 102 has knowledge of and is aware of client devices to which it is connected.

In another embodiment, the general-purpose wireless network may be a mobile phone network, such as a cellular phone network. Other types of mobile phone networks include a global system for mobile communication (GSM) network, a code division multiple access (CDMA) network, and a time division multiple access (TDMA) network. Still other types of mobile phone networks include an evolution data-optimized (EVDO) network, a third generation (3G) network, an enhanced data rates for GSM evolution (EDGE) network, an enhanced general packet radio service (EGPRS) network.

In such an embodiment, the transmitting device 102 may be a mobile phone network tower device that is commonly found throughout the United States. The transmitting device 102 in such instance communicates with other devices, such as client devices like mobile phone devices, mobile personal digital assistant (PDA) devices, and laptop computers having mobile phone device cards. The transmitting device 102 may enable these devices to connect to the Internet, an intranet, an extranet, or another type of network.

These devices establish connections with the transmitting device 102, so that they may send data to and receive data from or via the transmitting device 102. For instance, such a client device may when turned on send or receive a beacon signal looking for a transmitting device 102. In response, the transmitting device 102 may provide the client device with an address, such that the client device is now connected to the mobile phone network and to the transmitting device 102. Once the client device is so connected, it is able to wirelessly transmit data to and wirelessly receive data from the transmitting device 102, such as phone calls.

In this embodiment as well, the receiving device 104 is not a client device that actually connects to the transmitting device 102 or the general-purpose network in question. The receiving device 104 may have no wireless transmission capability, and may only be able to receive wireless signals sent over the wireless network. As such, the receiving device 104 is not actually connected to the general purpose wireless network, nor to the transmitting device 102. When the transmitting device 102 broadcasts a time signal, for instance, as will be described, it does not know that the receiving device 104 has received the time signal, and has no knowledge of the receiving device 104 more generally. By comparison, the transmitting device 102 has knowledge of and is aware of client devices to which it is connected.

The transmitting device 102 receives a time signal (106). The time signal represents the correct time for a given time zone, which may or may not be the time zone in which the transmitting device 102 is located. The time signal may be received by the transmitting device 102 over a wired or wireless network, including the general-purpose network to which the transmitting device 102 is connected. The time signal may be received by the transmitting device 102 in response to the device 102 sending a request for the current time to a network time protocol (NTP) server, as can be appreciated by those of ordinary skill within the art. The transmitting device 102 may even receive the time signal from the atomic clock located in Boulder, Colo., as has been described in the background section.

If the time signal represents the correct time for a time zone that is not the local time zone of the transmitting device 102, then the transmitting device 102 can adjust the time signal to the local time zone (108). For example, the time signal may represent Greenwich Mean Time (GMT), or Zulu time. Based on this knowledge, and the time zone in which the transmitting device 102 is located, the device 102 is able to correctly adjust the time so that the correct local time is realized.

Thereafter, the transmitting device 102 wirelessly broadcasts the time signal over the general purpose network (110). The time signal is broadcast over the general purpose network in that it is broadcasted in accordance with the protocol of the network in question, but is not directed to any particular client device connected to the transmitting device 102 and to the general purpose network. As such, the time signal is not wirelessly broadcasted in an encrypted manner, for instance, even if the general purpose wireless network provides only for encrypted communication between the client devices and the transmitting device 102. Thus, the time signal is wirelessly broadcasted in such a way that the receiving device 104 can receive the time signal, without having to first establish a connection with the transmitting device 102. The transmitting device 102 periodically repeats parts 106, 108, and/or 110 (112), such as every five or ten minutes in one embodiment of the invention.

The receiving device 104 wirelessly receives the wirelessly broadcast time signal over the general purpose network (114). As has been noted, the receiving device 104 has not established a connection with the general purpose wireless network or the transmitting device 102. Indeed, insofar as the receiving device 104 may not have transmitting capability, it is unable to connect to the wireless network or to the transmitting device 102, or even transmit any wireless signals whatsoever. Rather, the receiving device 104 is aware of the protocol in which the time signal is broadcast over the general purpose wireless network. The receiving device 104 continually listens to the frequency of the wireless network, and when it detects a data packet being sent that conforms to the protocol in which the time signal is encoded, the device 104 receives the time signal. The transmitting device 102 is thus unaware that the receiving device 104 has received the time signal, and indeed is unaware of the receiving device 104 itself.

Once the receiving device 104 has received the wirelessly broadcast time signal over the general purpose network, it sets an internal digital clock based on the time signal (116). For example, the receiving device 104 may be an alarm clock, a cooking device having a clock display, an audio/video device having an internal clock, and/or another type of electronic device. The receiving device 104 thus sets its internal clock to the time represented by the time signal. The receiving device 104 can periodically repeat parts 114 and 116 of the method 100 (118), so that even if its internal clock suffers from time drift, the internal clock will nevertheless always have substantially the correct time.

### System

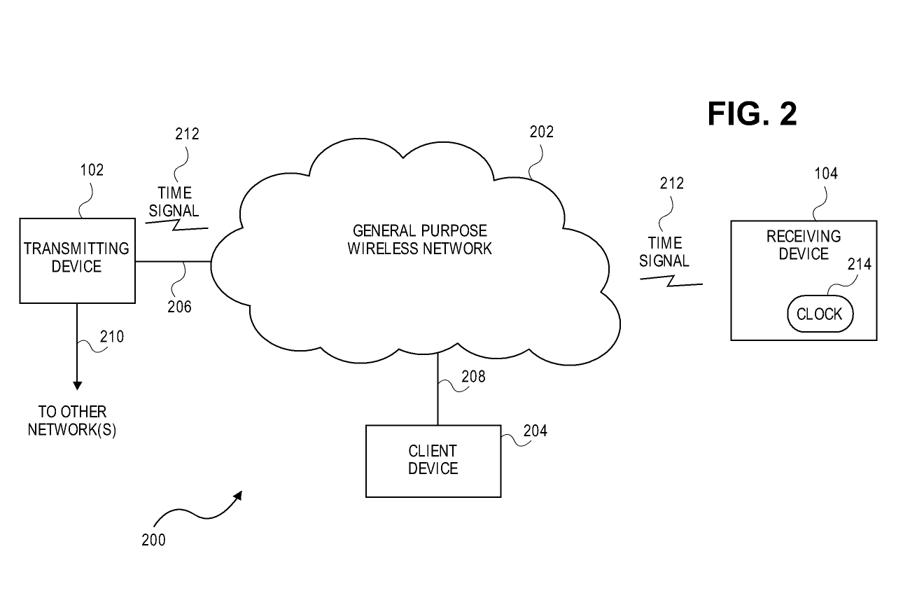

FIG. 2 shows a system 200, according to an embodiment of the invention. The system 200 includes the transmitting device 102, the receiving device 104, a general purpose wireless network 202, and a client device 204. As can be appreciated by those of ordinary skill within the art, the system 200 may have other devices or networks, in addition to those depicted in FIG. 2.

The general purpose wireless network 202, the transmitting device 102, the receiving device 104, and the client device 204 may be implemented as has been described in the preceding section of the detailed description. For example, the general purpose wireless network 202 may be a wireless Ethernet network or a mobile phone network in one embodiment. The transmitting device 102 may be an access point device or a router device where the general purpose wireless network 202 is a wireless Ethernet network, and may be a mobile phone network tower device where the general purpose wireless network 202 is a mobile phone network. The receiving device 104 may be an electronic device that has an internal digital clock. The client device 204 may be a computing device, such as a laptop computer, a mobile phone device, such as a mobile phone, or another type of client device.

The transmitting device 102 is connected to the general purpose wireless network 202, as indicated by the solid line 206. Likewise, the client device 204 is connected to the general purpose wireless network 202, and thus to the transmitting device 102, as indicated by the solid line 208. This means that the transmitting device 102 is aware of and has knowledge of the client device 204, and vice-versa. Furthermore, the transmitting device 102 is able to send data to and receive data from the client device 204 and vice-versa.

By comparison, the receiving device 104 is not connected to the general purpose wireless network 202, nor to the transmitting device 102; there is no solid line connecting the receiving device 104 to the network 202 in FIG. 2, for instance. As such, the receiving device 104 is not able to send data to any device on the general purpose wireless network 202, such as the transmitting device 102 or the client device 204. The receiving device 104 in fact is not able to receive data particularly intended for the device 104 from any device on the general purpose wireless network 202. While the transmitting device 102 is able to wirelessly broadcast a time signal over the general purpose wireless network 202, as has been described in the previous section of the detailed description, this signal is not particularly intended for any specific device, such as the receiving device 104.

Rather, the receiving device 104 simply listens for such time signal broadcasts, and uses the time signal to set its internal digital clock 214, as has been described in the preceding section of the detailed description. That is, the transmitting device 102 wirelessly broadcasts a time signal over the general purpose wireless network 202 not for the benefit of any particular or specific device, such as the receiving device 104, but rather for any device that wishes to use or receive the time signal. In this way, broadcasting of the time signal by the transmitting device 102 is different than other data transmissions, and indeed other data broadcasts, by the transmitting device 102 over the general purpose wireless network 202, to client devices like the client device 204. For example, even if the transmitting device 102 were to broadcast data to all client devices, like the client device 204, such data broadcasting is inherently intended for all client devices, of which the transmitting device 102 is particularly aware insofar as the client devices have established connections to the network 202 and thus to the device 102.

The transmitting device 102, as indicated by the arrow 210, may also be connected to one or more other networks. The transmitting device 102 may receive the time signal, or the time that is to be wirelessly broadcast as the time signal, from these other networks, such as from an NTP server, as has been described. Furthermore, the transmitting device 102 may communicate data from these other networks to the client devices 204 connected to the transmitting device 102, and vice-versa. However, except for the transmitting device 102 potentially receiving the time signal from these other networks, the connection of the transmitting device 102 to the other networks is irrelevant insofar as the receiving device 104 is concerned. The receiving device 104 cannot transmit data to these other networks via the transmitting device 102, for instance.

### Receiving Device

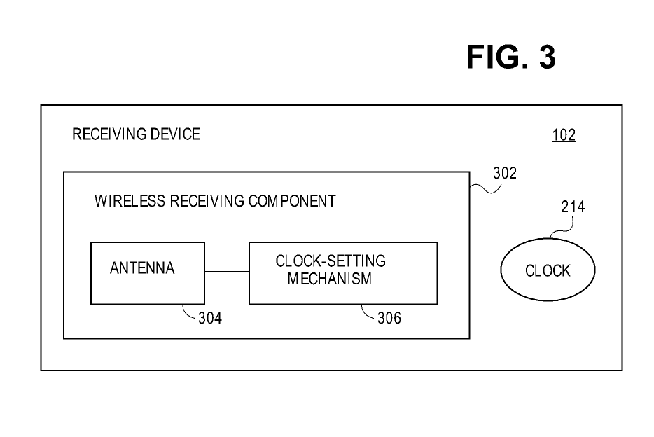

FIG. 3 shows the receiving device 102 in detail, according to an embodiment of the invention. The receiving device 102 includes the internal digital clock 214, as well as a wireless receiving component 302, which itself includes an antenna 304 and a clock-setting mechanism 306. As can be appreciated by those of ordinary skill within the art, either or both of the receiving device 102 and the wireless receiving component 302 may include other mechanisms and components, in addition to and/or in lieu of those depicted in FIG. 3. As has been described, the receiving device 102 is generally an electronic device that has an internal digital clock, like the clock 214.

The wireless receiving component 302 may be implemented as an integrated circuit (IC), or in another manner. The wireless receiving component 302 may be a separately available component that receiving device designers and manufacturers can incorporate into their receiving devices. The antenna 304 enables the receiving device 102 to wirelessly receive a time signal wirelessly broadcast by the transmitting device 102 over the general purpose wireless network 202, as has been described in the previous section of the detailed description. That is, the antenna 304, and thus the wireless receiving component 302, are unable to transmit signals, and only able to receive them. The antenna 304 and, thus, the wireless receiving component 302 are able to receive a time signal over the general purpose wireless network 202 without having established a connection to the network 202 or to the transmitting device 102.

The clock-setting mechanism 306 may be logic that receives the time signal via the antenna 304, and in response updates the internal digital clock 214 of the receiving device 214. The clock-setting mechanism 306 may therefore provide an output corresponding to the time represented by the received time signal, in a standard format that designers and manufactures of receiving devices having internal clocks can use. In one embodiment, however, the wireless receiving component 302 may alternatively include the internal digital clock 214, as a local clock of the wireless receiving component 302. In such an embodiment, therefore, the receiving device 102 does not have to have its own clock, but rather can communicate with the clock of the wireless receiving component 302 in accordance with a standard format to learn the current time.

### CONCLUSION

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method comprising:
a transmitting device generating a time signal; and,
the transmitting device wirelessly broadcasting the time signal over a general purpose wireless network, the time signal wirelessly broadcast in such a way that receiving devices receive the time signal without having established connections with the transmitting device.

2. The method of claim 1, further comprising the transmitting device periodically repeating wirelessly broadcasting the time signal over the general purpose wireless network.

3. The method of claim 1, wherein the time signal generated by the transmitting device is in relation to a time zone different than a time zone in which the transmitting device is located, the method further comprising the transmitting device adjusting the time signal so that the time signal reflects correct local time within the time zone in which the transmitting device is located prior to wirelessly broadcasting the time signal over the general purpose wireless network.

4. The method of claim 1, wherein the general purpose wireless network is one or more of an: 802.11a, 802.11b, 802.11g, 802.11n, and a Bluetooth wireless network, and the transmitting device is one of a router device and an access point device that communicates with other devices that are connected to the transmitting device on the general purpose wireless network other than the receiving devices.

5. The method of claim 1, wherein the general purpose wireless network is a mobile phone network, and the transmitting device is a mobile phone tower device that communicates with other devices that are connected to the mobile phone tower device on the mobile phone network other than the receiving devices.

6. A method comprising:
a receiving device wirelessly receiving a time signal wirelessly broadcast by a transmitting device over a general purpose wireless network without having established a connection with the transmitting device; and,
the receiving device setting a clock of the receiving device based on the time signal wirelessly received.

7. The method of claim 6, further comprising the receiving device periodically wirelessly receiving the time signal and setting the clock thereof based on the time signal wirelessly received.

8. The method of claim 6, wherein the receiving device is unable to transmit signals over the general purpose wireless network.

9. The method of claim 6, wherein the general purpose wireless network is one or more of an: 802.11a, 802.11b, 802.11g, 802.11n, and a Bluetooth wireless network, and the transmitting device is one of a router device and an access point device that communicates with other devices that are connected to the transmitting device on the general purpose wireless network other than the receiving device.

10. The method of claim 6, wherein the general purpose wireless network is a mobile phone network, and the transmitting device is a mobile phone tower device that communicates with other devices that are connected to the mobile phone tower device on the mobile phone network other than the receiving device.

11. A system comprising:
a transmitting device that is to wirelessly broadcast a time signal over a general purpose wireless network; and,
a receiving device that is to wirelessly receive the time signal without having established a connection with the transmitting device over the general purpose wireless network and to set a clock of the receiving device based on the time signal wirelessly received.

12. The system of claim 11, wherein the general purpose wireless network is one or more of an: 802.11a, 802.11b, 802.11g, 802.11n, and a Bluetooth wireless network, and the transmitting device is one of a router device and an access point device that communicates with other devices that are connected to the transmitting device on the general purpose wireless network other than the receiving device.

13. The system of claim 11, wherein the general purpose wireless network is a mobile phone network, and the transmitting device is a mobile phone tower device that communicates with other devices that are connected to the mobile phone tower device on the mobile phone network other than the receiving device.

14. The system of claim 11, wherein the receiving device is unable to transmit signals over the general purpose wireless network.

15. A wireless receiving component for an electronic device, comprising:
an antenna mechanism to wirelessly receive a time signal wirelessly broadcast by a transmitting device over a general purpose wireless network without the wireless receiving component or the electronic device having established a connection with the transmitting device; and,
a mechanism to update a local clock of the electronic device based on the time signal wirelessly received.

16. The wireless receiving component of claim 15, further comprising the local clock that is updated based on the time signal wirelessly received.

17. The wireless receiving component of claim 15, wherein the wireless receiving component is unable to transmit signals over the general purpose wireless network.

18. The wireless receiving component of claim 15, wherein the general purpose wireless network is one or more of an: 802.11a, 802.11b, 802.11g, 802.11n, and a Bluetooth wireless network, and the transmitting device is one of a router device and an access point device that communicates with other devices that are connected to the transmitting device on the general purpose wireless network other than the receiving device.

19. The wireless receiving component of claim 15, wherein the general purpose wireless network is a mobile phone network, and the transmitting device is a mobile phone tower device that communicates with other devices that are connected to the mobile phone tower device on the mobile phone network other than the receiving device.

20. The wireless receiving component of claim 15, wherein the wireless receiving component comprises an integrated circuit (IC).
